(19) United States
(12) Patent Application Publication
(10) Pub. No.: US 2022/0404060 A1
(43) Pub. Date: Dec. 22, 2022

(54) HOUSEHOLD VENTILATION APPARATUS CAPABLE OF ADJUSTING AIR VELOCITY IN MULTIPLE STAGES

(71) Applicant: HIMPEL CO., LTD., Hwaseong-si, Gyeonggi-do (KR)

(72) Inventor: Jung Hwan KIM, Anyang-si, Gyeonggi-do (KR)

(21) Appl. No.: 17/779,177

(22) PCT Filed: Dec. 1, 2020
(86) PCT No.: PCT/KR2020/017367

§ 371 Date: May 24, 2022

(30) Foreign Application Priority Data
Dec. 2, 2019 (KR) 10-2019-0158336

(51) Int. Cl. F24F 11/77; F24F 11/00

(52) U.S. Cl. CPC F24F 11/77; F24F 11/0001; F24F 2110/40

(57) ABSTRACT

Proposed is a household ventilation apparatus capable of adjusting air velocity in multiple stages and, particularly, a household ventilation apparatus capable of adjusting air velocity in multiple stages, which is installed in a bathroom and the like of a building such as an apartment so as to adjust the ventilation speed and to change the ventilation speed such that noise is reduced or rapid ventilation is performed depending on a user's preference and the like. The household ventilation apparatus includes: a housing; a motor mounted in the housing; a fan member mounted on the motor so as to rotate; an air volume adjusting unit for setting the magnitude of the air volume of the fan member by means of external input; and a control unit for controlling the rotational speed of the motor in accordance with a set value of the air volume of the air volume adjusting unit.

### TECHNICAL FIELD

The present invention relates to a household ventilation apparatus capable of adjusting air velocity in multiple stages and, particularly, to a household ventilation apparatus capable of adjusting air velocity in multiple stages, which is installed in a bathroom and the like of a building such as an apartment so as to adjust the ventilation speed and to change the ventilation speed such that noise is reduced or rapid ventilation is performed depending on a user's preference and the like.

### BACKGROUND ART

In general, a ventilation fan is installed at a bathroom in each household of a multi-unit houses such as apartment to emit, to the outside, an odor from a toilet, a drain, or the like and an excessive amount of moisture formed during taking a bath or a shower. The odor and the moisture through the ventilation fan are collected through one ventilation duct provided in the multi-unit houses and are emitted to the outside.

However, such ventilation structure has a difference in pressure between low and high floors depending on season. For example, in wintertime, unclean air emitted from a ventilation fan at a low floor flows along a ventilation duct without causing a big problem; however, since unclean air emitted from a ventilation fan at a high floor joins unclean air from low floors inside the ventilation duct and forms high-pressure air, a headwind is formed toward the ventilation fan from the ventilation duct, as a floor gets higher, and thus a problem arises in that it is difficult to emit an equal amount of air from every floor.

In other words, when ventilation fans having the same output are installed at low and high floors of a high-rise building, a rotational speed of a ventilation fan at a low floor is unnecessarily high for emitting indoor odor and moisture, and an output of a ventilation fan installed at a high floor is too low for emitting indoor odor and moisture. Hence, a problem arises in that it is not possible to maximize an emission effect of unclean air.

In order to solve the problems, ventilation fans installed in the high-rise building have to be divided into three groups for low, middle, and high floors so as to be designed and manufactured to have different rotational speeds depending on the group and divided to be installed, and thus a problem of high costs for manufacturing and installation arises.

In particular, since it is not possible to adjust the rotational speed of the ventilation fan depending on a purpose of bathroom use of a user, problems arise in that it is not possible to rapidly emit, to the outside, a large amount of steam which is temporarily generated during taking a bath or a shower and that noise of the ventilation fan during the operation thereof is loud to a user who is sensitive to noise.

### SUMMARY OF INVENTION

### Technical Problem

The present invention is made to solve the problems described above, and an object thereof is to provide a household ventilation apparatus capable of adjusting air velocity in multiple stages, which is installed in a bathroom and the like of a building such as an apartment so as to adjust the ventilation speed and to change the ventilation speed such that noise is reduced or rapid ventilation is performed depending on a user's preference and the like.

### Solution to Problem

A household ventilation apparatus capable of adjusting air velocity in multiple stages of the present invention includes: a housing; a motor mounted in the housing; a fan member mounted on the motor so as to rotate; an air volume adjusting unit for setting the magnitude of the air volume of the fan member by means of external input; and a control unit for controlling the rotational speed of the motor in accordance with a set value of the air volume of the air volume adjusting unit. The control unit performs control such that, when the same air volume is set by the air volume adjusting unit, the rotational speed of the motor at a place having a high vent pressure is set to be higher than the rotational speed of the motor at a place having a low vent pressure.

The control unit has control modes including: a normal mode for adjusting the rotational speed of the motor in proportion to the set value of the air volume set by the air volume adjusting unit; and a low noise mode for adjusting the rotational speed of the motor to be smaller than a proportional value in accordance with the normal mode when the set value of the air volume set by the air volume adjusting unit is smaller than a preset first reference value.

In addition, the control unit has control modes including: a normal mode for adjusting the rotational speed of the motor in proportion to set value of the air volume set by the air volume adjusting unit; and a turbo mode for adjusting the rotational speed of the motor to be larger than a proportional value in accordance with the normal mode when the set value of the air volume set by the air volume adjusting unit is larger than a preset second reference value.

The control unit has control modes including: a normal mode for adjusting the rotational speed of the motor in proportion to the set value of the air volume set by the air volume adjusting unit; a low noise mode for adjusting the rotational speed of the motor to be smaller than a proportional value in accordance with the normal mode when the set value of the air volume set by the air volume adjusting unit is smaller than a preset first reference value; and a turbo mode for adjusting the rotational speed of the motor to be larger than the proportional value in accordance with the normal mode when the set value of the air volume set by the air volume adjusting unit is larger than a preset second reference value. Here, the second reference value is larger than the first reference value.

During operation of the turbo mode, the control unit converts the turbo mode to the normal mode after a preset time.

The household ventilation apparatus capable of adjusting air velocity in multiple stages further includes a pressure sensor that is disposed behind the fan member and measures pressure. The control unit does not perform the low noise mode when a measured pressure measured by the pressure sensor is lower than a preset reference pressure.

The household ventilation apparatus capable of adjusting air velocity in multiple stages further includes a noise measuring sensor that measures noise generated during rotation of the fan member. In the low noise mode, the control unit adjusts the rotational speed of the motor to a lower speed such that a measured noise measured by the noise measuring sensor is lower than a preset reference noise.

### Advantageous Effects of Invention

According to the present invention as described above, a household ventilation apparatus capable of adjusting air velocity in multiple stages has the following effects.

The present invention described above can be installed at a bathroom, a restroom, or the like so that a user can adjust a magnitude of the air volume as necessary by adjusting a rotational speed of a motor in multiple stages, and particularly has a low noise mode and a turbo mode so that modes can be easily changed for noise reduction or rapid ventilation depending on user preference, an environment, or the like.

### BRIEF DESCRIPTION OF DRAWINGS

FIG. 1 is a configurational diagram of a household ventilation apparatus capable of adjusting air velocity in multiple stages according to an embodiment of the present invention.

FIG. 2 is a flowchart of the household ventilation apparatus capable of adjusting air velocity in multiple stages according to the embodiment of the present invention.

### DESCRIPTION OF EMBODIMENTS

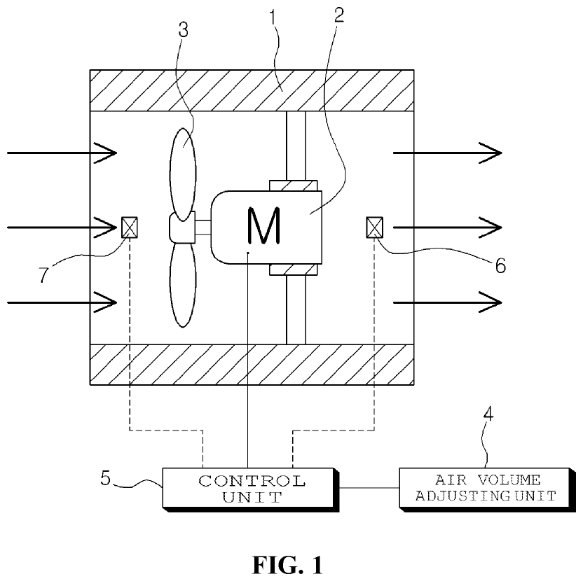

A household ventilation apparatus capable of adjusting air velocity in multiple stages of the present invention is configured to include a housing 1, a motor 2, a fan member 3, an air volume adjusting unit 4, and a control unit 5 as illustrated in FIG. 1.

The housing 1 can have various shapes and has a flow channel inside, the flow channel enabling air to flow.

The motor 2 is mounted in the housing 1.

The fan member 3 is mounted on the motor 2 so as to rotate.

The air volume adjusting unit 4 sets a magnitude of air volume of the fan member 3 by means of external input.

In other words, the air volume adjusting unit 4 enables a user to adjust a magnitude of air volume of the fan member 3, and the magnitude of air volume of the fan member 3 is set by means of the external input by a user such that a set value of the air volume is set.

The magnitude of air volume of the fan member 3 is determined by rotational power of the motor 2.

The air volume adjusting unit 4 can adjust the magnitude of air volume of the fan member 3 determined by the rotational of the motor 3 in multiple stages, and the motor 2 is configured of a BLDC motor or the like which can adjust the rotational speed thereof or the like.

The control unit 5 controls the rotational speed of the motor 2 in accordance with the set value of the air volume of the air volume adjusting unit 4.

When the same air volume is set by the air volume adjusting unit 4, the control unit 5 increases the rotational speed of the motor 2 at a location having high pressure than the rotational speed of the motor 2 at a location having low pressure.

For example, when a user sets the set value of the air volume to stage 3 through the air volume adjusting unit 4, the motor 2 rotates at a preset rotational speed corresponding to the stage 3.

In this case, in a case of a building such as an apartment, air emitted from ventilators gathers in one ventilation duct, flows upward, and is emitted to the outside.

The ventilation duct has a difference in pressure between low and high floors of the building such as an apartment, and such difference becomes more significant when an indoor and outdoor temperature difference is big as in summertime or wintertime.

For example, in a case of the wintertime, air emitted from the ventilators at a high floor joins air from the low floors inside the ventilation duct and forms high-pressure air, and thus pressure of the ventilation duct increases toward the higher floors.

Under these background conditions, when the rotational speed of the motor 2 of the ventilator installed at a low floor is set to the same as the rotational speed of the motor 2 of the ventilator installed at a high floor, magnitudes of air volume actually generated through the fan member 3 are not the same but different values due to a difference in pressure between the low floor and the high floor, and thus a problem arises in that the magnitude of air volume is not equal but is different depending on the height of a building.

However, according to the present invention, the control unit 5 causes the rotational speed of the motor 2 of the ventilator installed at the low floor at which the ventilation duct has the low pressure to be smaller than that at the high floor and causes the rotational speed of the motor 2 of the ventilator installed at the high floor at which the ventilation duct has the high pressure to be greater than that at the low floor.

Further, since the high floor has the low pressure and the low floor has the high pressure in a case of the summertime, the control unit 5 causes the rotational speed of the motor 2 of the ventilator installed at the high floor at which the ventilation duct has the low pressure to be smaller than that at the low floor and causes the rotational speed of the motor 2 of the ventilator installed at the low floor at which the ventilation duct has the high pressure to be greater than that at the high floor.

In this manner, it is possible for air volumes with same magnitude to be generated from the fan members 3 at the ventilators installed both the low and high floors of a building in which the ventilation duct has a pressure difference.

In other words, according to the present invention, when a user sets the set value of the air volume to stage 3 through the air volume adjusting unit 4, the same air volume can be generated regardless of the low or high floors of a building in which the ventilators are installed.

The control unit 5 of the present invention is configured to have two or more control modes.

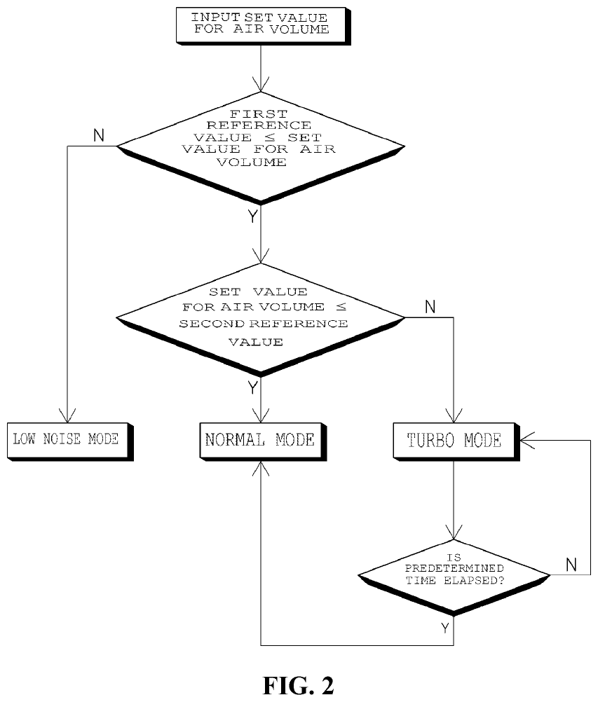

In FIG. 2, the control unit 5 has a total of three control modes, that is, a normal mode, a low noise mode, and a turbo mode.

In some cases, the control mode can only include the normal mode and the low noise mode or can only include the normal mode and the turbo mode.

In the embodiment, the control mode includes the normal mode, the low noise mode, and the turbo mode.

Hereinafter, for convenience of description, as illustrated in Table 1 below, a stage 1 of the air volume adjusting unit 4 is referred to as the low noise mode, stages 2, 3, and 4 thereof are referred to as the normal mode, and the stage 5 is referred to as the turbo mode.

Hereinafter, in the embodiment, each of the low noise mode and the turbo mode is described with one stage; however, the low noise mode and the turbo mode, in addition to the normal mode, can be configured of various stages as the case may be.

The magnitude of air volume increases from the stage 1 to a stage 7 of the air volume adjusting unit 4.

TABLE 1

| Control | Low noise | | | | Turbo |
|---|---|---|---|---|---|
| modes | mode | Normal mode | | | mode |
| Stages of | Stage 1 | Stage 2 | Stage 3 | Stage 4 | Stage 5 |
| magnitude of | | | | | |
| air volume | | | | | |
| Rotational | 5 | 20 | 30 | 40 | 70 |
| speed of | | | | | |
| motor 2 | | | | | |

The normal mode is a mode for adjusting the rotational speed of the motor 2 in proportion to the set value of the air volume set by the air volume adjusting unit 4. In other words, when the set value of the air volume increases through the stage 2, stage 3, and stage 4 in the normal mode, the magnitude of air volume gradually increases as the rotational speed of the motor 2 gradually increases through 20, 30, and 40 in proportion to the respective stages as illustrated in Table 1.

The low noise mode is a mode for reducing noise generated during the rotation of the fan member 3, and when the set value for the air volume set by the air volume adjusting unit 4 is smaller than a preset first reference value, the rotational speed of the motor 2 is adjusted to be lower than the proportional value in accordance with the normal mode.

In the low noise mode, when the set value of the air volume is changed to the preset first reference value, that is, the stage 1 lower than the stage 2 which has the lowest value of the normal mode, the rotational speed of the motor 2 is adjusted to be lower than the proportional value in accordance with the normal mode.

In other words, when the rotational speed of the motor 2 is 30 at the stage 3 and the rotational speed of the motor 2 is 20 at the stage 2, the rotational speed of the motor 2 is to be 10 at the stage 1 proportionally.

However, in the present invention, when the stage is changed to the stage 1, that is, the low noise mode, the rotational speed of the motor 2 is not adjusted to 10 but is adjusted to 5 smaller than 10 as illustrated in Table 1.

As described above, in the low noise mode, the rotational speed of the motor 2 is adjusted to be lower than the proportional value in accordance with the normal mode, and thereby noise due to the rotation of the motor 2 and the fan member 3 can be significantly reduced.

The turbo mode is a mode for increasing the rotational speed of the fan member 3 to achieve rapid ventilation of moisture, odor, or the like, and when the set value of the air volume set by the air volume adjusting unit 4 is larger than a preset second reference value, the rotational speed of the motor 2 is adjusted to be higher than a proportional value in accordance with the normal mode.

In the turbo mode, when the set value of the air volume is changed to the preset second reference value, that is, the stage 5 higher than the stage 4 which has the highest value of the normal mode, the rotational speed of the motor 2 is adjusted to be higher than the proportional value in accordance with the normal mode.

In other words, when the rotational speed of the motor 2 is 30 at the stage 3 and the rotational speed of the motor 2 is 40 at the stage 4, the rotational speed of the motor 2 is to be 50 at the stage 5 proportionally.

However, in the present invention, when the stage is changed to the stage 5, that is, the turbo mode, the rotational speed of the motor 2 is not adjusted to 50 but is adjusted to 70 larger than 50 as illustrated in Table 1.

As described above, in the turbo mode, the rotational speed of the motor 2 is adjusted to be higher than the proportional value in accordance with the normal mode, and thereby the rapid ventilation is achieved due to the rotation of the motor 2 and the fan member 3.

The second reference value by which the normal mode and the turbo mode are distinguished from each other is larger than the first reference value by which the normal mode and the low noise mode are distinguished from each other.

In addition, during the operation of the turbo mode, the control unit 5 is to convert the turbo mode to the normal mode after a preset time.

In this manner, it is possible to inhibit loud noise due to the turbo mode from being continuously generated after the ventilation is achieved through the turbo mode.

Meanwhile, the present invention can be configured to further include a pressure sensor 6 and a noise measuring sensor 7.

The pressure sensor 6 is a sensor that is disposed behind the fan member 3 and measures pressure of a duct connected to the housing 1 or a ventilation duct.

The control unit 5 does not perform the low noise mode when a measured pressure measured by the pressure sensor 6 is lower than a preset reference pressure.

Since a low noise is generated during the rotation of the fan member 3 when the measured pressure measured by the pressure sensor 6 is low, it is possible to inhibit loud noise from being generated even when the operation is performed in the normal mode without performing the low noise mode.

The noise measuring sensor 7 measures noise generated during the rotation of the fan member 3.

In the drawing of the embodiment, the noise measuring sensor 7 is disposed in front of the fan member 3.

When the control mode is changed to the low noise mode, the control unit 5 adjusts the rotational speed of the motor 2 to a lower speed such that a measured noise measured by the noise measuring sensor 7 is lower than a preset reference noise.

In other words, the low noise mode is provided to reduce noise, and noise is reduced by decreasing the rotational speed of the motor 2 when the measured noise measured by the noise measuring sensor 7 is higher than a reference noise.

The present invention described above can be installed at a bathroom, a restroom, or the like so that a user can adjust a magnitude of the air volume as necessary by adjusting a rotational speed of a motor 2 in multiple stages, and particularly has a low noise mode and a turbo mode so that modes can be easily changed for noise reduction or rapid ventilation depending on user preference, an environment, or the like.

The household ventilation apparatus capable of adjusting air velocity in multiple stages as the present invention is not limited to the embodiment described above and can be variously modified within the scope of the technical idea of the present invention.

### INDUSTRIAL APPLICABILITY

The present invention can be applied to a household ventilation apparatus to adjust air velocity in multiple stages, and thus is industrially applicable.

1. A household ventilation apparatus capable of adjusting air velocity in multiple stages, comprising:
a housing;
a motor mounted in the housing;
a fan member mounted on the motor so as to rotate;
an air volume adjusting unit for setting the magnitude of the air volume of the fan member by means of external input; and
a control unit for controlling the rotational speed of the motor in accordance with a set value of the air volume of the air volume adjusting unit,
wherein, when the same air volume is set by the air volume adjusting unit, the rotational speed of the motor at a place having a high vent pressure is set to be higher than the rotational speed of the motor at a place having a low vent pressure.

2. The household ventilation apparatus capable of adjusting air velocity in multiple stages according to claim 1,
wherein the control unit has control modes including:
a normal mode for adjusting the rotational speed of the motor in proportion to the set value of the air volume set by the air volume adjusting unit; and
a low noise mode for adjusting the rotational speed of the motor to be smaller than a proportional value in accordance with the normal mode when the set value of the air volume set by the air volume adjusting unit is smaller than a preset first reference value.

3. The household ventilation apparatus capable of adjusting air velocity in multiple stages according to claim 1,
wherein the control unit has control modes including:
a normal mode for adjusting the rotational speed of the motor in proportion to the set value of the air volume set by the air volume adjusting unit; and
a turbo mode for adjusting the rotational speed of the motor to be larger than a proportional value in accordance with the normal mode when the set value of the air volume set by the air volume adjusting unit is larger than a preset second reference value.

4. The household ventilation apparatus capable of adjusting air velocity in multiple stages according to claim 1,
wherein the control unit has control modes including:
a normal mode for adjusting the rotational speed of the motor in proportion to the set value of the air volume set by the air volume adjusting unit;
a low noise mode for adjusting the rotational speed of the motor to be smaller than a proportional value in accordance with the normal mode when the set value of the air volume set by the air volume adjusting unit is smaller than a preset first reference value; and
a turbo mode for adjusting the rotational speed of the motor to be larger than a proportional value in accordance with the normal mode when the set value of the air volume set by the air volume adjusting unit is larger than a preset second reference value,
wherein the second reference value is larger than the first reference value.

5. The household ventilation apparatus capable of adjusting air velocity in multiple stages according to claim 3,
wherein, during operation of the turbo mode, the control unit converts the turbo mode to the normal mode after a preset time.

6. The household ventilation apparatus capable of adjusting air velocity in multiple stages according to claim 2, further comprising:
a pressure sensor that is disposed behind the fan member and measures pressure,
wherein the control unit does not perform the low noise mode when a measured pressure measured by the pressure sensor is lower than a preset reference pressure.

7. The household ventilation apparatus capable of adjusting air velocity in multiple stages according to claim 2, further comprising:
a noise measuring sensor that measures noise produced during rotation of the fan member, and
wherein, in the low noise mode, the control unit adjusts the rotational speed of the motor to a lower speed such that a measured noise measured by the noise measuring sensor is lower than a preset reference noise.

8. The household ventilation apparatus capable of adjusting air velocity in multiple stages according to claim 4,
wherein, during operation of the turbo mode, the control unit converts the turbo mode to the normal mode after a preset time.

9. The household ventilation apparatus capable of adjusting air velocity in multiple stages according to claim 4, further comprising:
a pressure sensor that is disposed behind the fan member and measures pressure,
wherein the control unit does not perform the low noise mode when a measured pressure measured by the pressure sensor is lower than a preset reference pressure.

10. The household ventilation apparatus capable of adjusting air velocity in multiple stages according to claim 4, further comprising:
a noise measuring sensor that measures noise produced during rotation of the fan member, and
wherein, in the low noise mode, the control unit adjusts the rotational speed of the motor to a lower speed such that a measured noise measured by the noise measuring sensor is lower than a preset reference noise.
